(19) United States
(12) Patent Application Publication
(10) Pub. No.: US 2018/0204555 A1
(43) Pub. Date: Jul. 19, 2018

(54) Mounting Device for a Pedal Board Assembly

(71) Applicant: MYE Entertainment, Inc., Stevenson Ranch, CA (US)

(72) Inventors: Anthony E. Garcia, Stevenson Ranch, CA (US); Christopher P. Hern, Valencia, CA (US)

(73) Assignee: MYE Entertainment, Inc., Stevenson Ranch, CA (US)

(21) Appl. No.: 15/891,528

(22) Filed: Feb. 8, 2018

Related U.S. Application Data
(60) Provisional application No. 62/448,063, filed on Jan. 19, 2017.

(51) Int. Cl. G10H 1/34; G10H 1/00; H01H 21/26

(52) U.S. Cl. CPC G10H 1/348; H01H 21/26; G10H 1/0091

(57) ABSTRACT

A pedal board assembly is provided and includes a pedal board, a mounting article and a component, wherein the pedal board includes a board top, a board bottom and a board length, wherein the pedal board further includes a board opening which communicates the board top with the board bottom and extends at least a portion of the board length, wherein the pedal board is configured to movably associate with a mounting article which is configured to move along at least a portion of the board opening.

### CROSS REFERENCE TO RELATED APPLICATIONS

The application is related to and claims the benefit of the filing date of U.S. Provisional Patent Application Ser. No. 62/448,063 filed Jan. 19, 2017, the contents of which are incorporated herein by reference in its entirety.

### FIELD OF THE INVENTION

The present invention relates generally to pedal board and more particularly to a power supply and an adjustable mounting device for a pedal board.

### BACKGROUND OF THE INVENTION

Pedal boards are well known in the musical industry and are typically flat boards or panels that serve as a container or platform for instrument effects pedals. Some current pedal board designs include power supplies, transformers and power cables to provide power to a number of different pedals and in some cases, other pedal boards. Unfortunately however, the current pedal board designs that include power components have a limited amount of space available because the power components typically occupy space that could be used by effects pedals. Additionally, the power components that exist on current pedal designs are stationary and not configurable.

### SUMMARY OF THE INVENTION

A pedal board assembly is provided and includes a pedal board having a board top, a board bottom and a board length, wherein the pedal board further includes a board opening which communicates the board top with the board bottom and extends at least a portion of the board length. Additionally, the pedal board assembly further includes a component, wherein the component includes a supply enclosure having an enclosure top. Moreover, the pedal board assembly also includes a mounting article, wherein the mounting article includes an article center portion a first article side portion and a second article side portion, wherein the first article side portion is located on one side of the article center portion and the second article side portion is located on the other side of the article center portion, and wherein the mounting article is configured to movably associate with the pedal board such that the article center portion is located within the board opening and the first article side portion and the second article side portion are located adjacent the article top, and wherein when the mounting article is movably associated with the pedal board, the component is securely connected to the article center portion such that the component is located adjacent to the board bottom.

A pedal board assembly is provided and includes a pedal board having a board top, a board bottom and a board length, wherein the pedal board further includes a board opening which communicates the board top with the board bottom and extends at least a portion of the board length. Furthermore, the pedal board assembly includes a mounting article, wherein the mounting article includes an article center portion a first article side portion and a second article side portion, wherein the first article side portion is located on one side of the article center portion and the second article side portion is located on the other side of the article center portion, and wherein mounting article is configured to securely associate with a component and movably associate with the pedal board such that the article center portion is located within the board opening and the first article side portion and the second article side portion are located adjacent the article top, and wherein the mounting article is securely associated with a component, the component is located adjacent to the board bottom.

A pedal board assembly is provided and includes a pedal board having a board top, a board bottom and a board length, wherein the pedal board further includes a board opening which communicates the board top with the board bottom and extends at least a portion of the board length, wherein the pedal board is configured to movably associate with a mounting article which is configured to move along at least a portion of the board opening.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike in the several Figures:

FIG. 1 is a top down perspective view of a pedal board assembly, in accordance with one embodiment of the invention.

FIG. 2 is a bottom end view of the pedal board assembly of FIG. 1 illustrating a power supply located within the board cavity, in accordance with one embodiment of the invention.

FIG. 3 is a top down perspective view of a pedal board for use with the pedal board assembly of FIG. 1, in accordance with one embodiment of the invention.

FIG. 4 is a top down perspective view of a pedal board for the pedal board assembly of FIG. 1, in accordance with one embodiment of the invention.

FIG. 5A is a top down perspective view of a power supply for use with the pedal board assembly of FIG. 1, in accordance with one embodiment of the invention.

FIG. 5B is a top down perspective view of a power supply for use with the pedal board assembly of FIG. 1, in accordance with another embodiment of the invention.

FIG. 5C is a front view of the power supply of FIG. 5B, in accordance with one embodiment of the invention.

FIG. 5D is a rear view of the power supply of FIG. 5B, in accordance with one embodiment of the invention.

FIG. 6 is a side view of the power supply of FIG. 1, in accordance with one embodiment of the invention.

FIG. 7 is a bottom view of the power supply of FIG. 1, in accordance with one embodiment of the invention.

FIG. 8A is a top down view of a mounting article for use with the pedal board assembly of FIG. 1, in accordance with one embodiment of the invention.

FIG. 8B is an end view of the mounting article of FIG. 8A.

FIG. 8C is a side view of the mounting article of FIG. 8A.

FIG. 9A is an end view of a mounting article for use with the pedal board assembly of FIG. 1, in accordance with another embodiment of the invention.

FIG. 9B a side view of the mounting article of FIG. 9A.

FIG. 10 is an exploded view of the pedal board assembly of FIG. 1, in accordance with one embodiment of the invention.

FIG. 11 is a bottom view of a pedal board assembly, in accordance with another embodiment of the invention.

FIG. 12 is a bottom end perspective view of the pedal board assembly of FIG. 11 illustrating a power supply located within the board cavity, in accordance with one embodiment of the invention.

FIG. 13 illustrates multiple views of a mounting article for use with the pedal board assemblies of FIG. 1 and FIG. 11, in accordance with another embodiment of the invention.

FIG. 14 illustrates multiple views of the mounting article of FIG. 13.

FIG. 15 illustrates multiple views of a mounting article for use with the pedal board assemblies of FIG. 1 and FIG. 11, in accordance with still yet another embodiment of the invention.

FIG. 16 illustrates multiple views of the mounting article of FIG. 15.

FIG. 17 illustrates a side perspective view of a power supply and the mounting article of FIG. 13 and/or FIG. 15, in accordance with one embodiment of the invention.

FIG. 18 illustrates a side perspective view of a power supply and the mounting article of FIG. 13 and/or FIG. 15, in accordance with one embodiment of the invention.

### DETAILED DESCRIPTION OF THE INVENTION

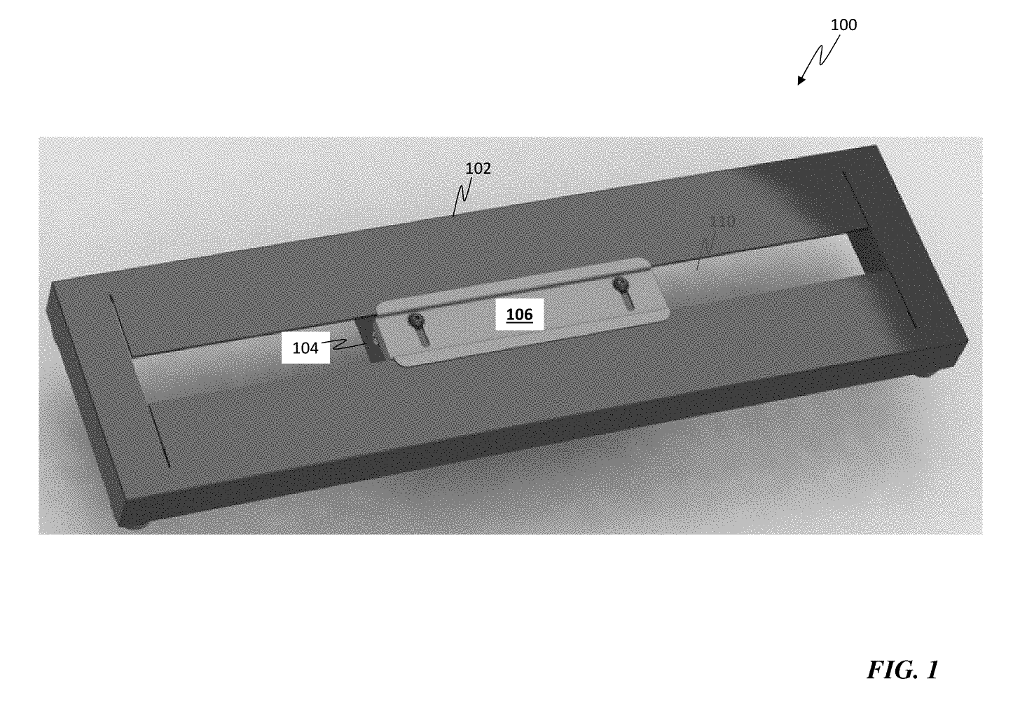

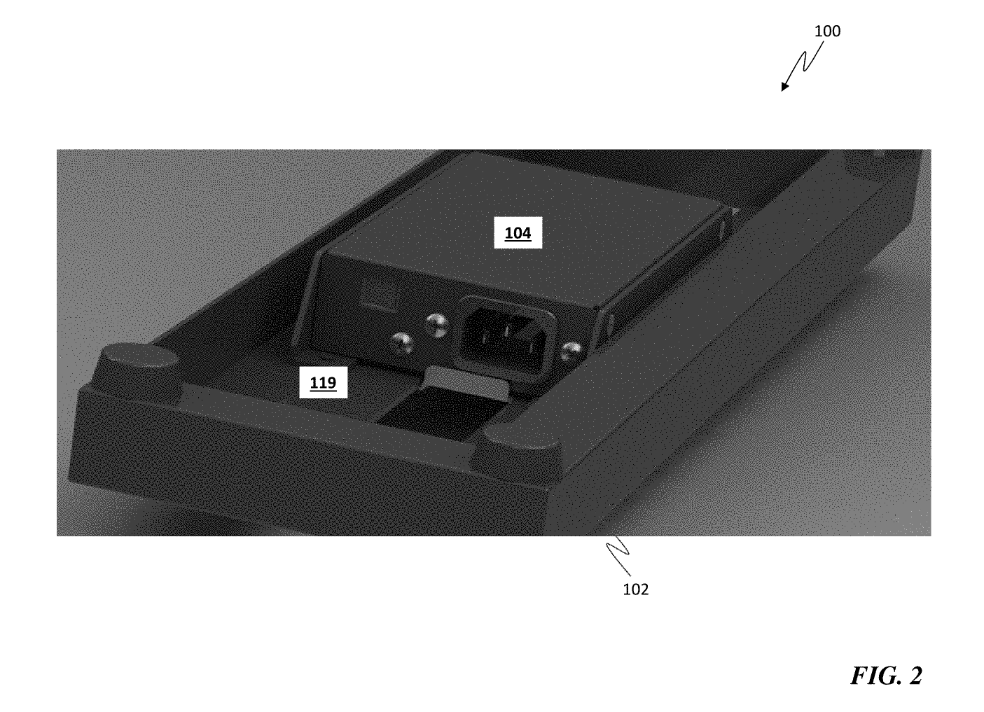

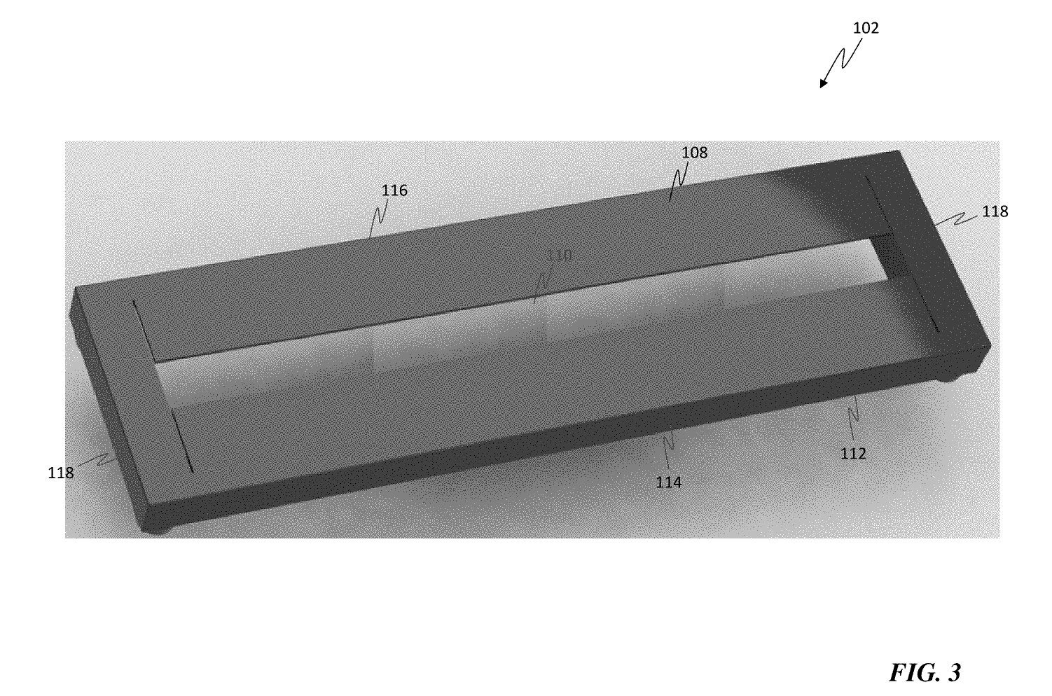

Referring to FIGS. 1-2, it should be appreciated that in accordance with the present invention a pedal board assembly 100 is provided and includes a pedal board 102, a component (such as a power supply) 104 and a mounting article 106, wherein the mounting article 106 movably associates the power supply 104 with the pedal board 102. Referring to FIGS. 2-4, the pedal board 102 is preferably constructed from a rigid material and includes pedal board structure 103 having a board length L and a board width W. The pedal board structure 103 includes a board top 108 defining a top opening 110 which extends at least a portion of the board length L, a board bottom 112, a board front 114, a board rear 116 and board sides 118. The pedal board structure 103 defines a board cavity 118 which extends at least a portion of the board length L and which is located under the board top 108, wherein the top opening 110 is communicated with the board cavity 118. Accordingly, the top opening 118 includes a top opening length TOL and a top opening width TOW.

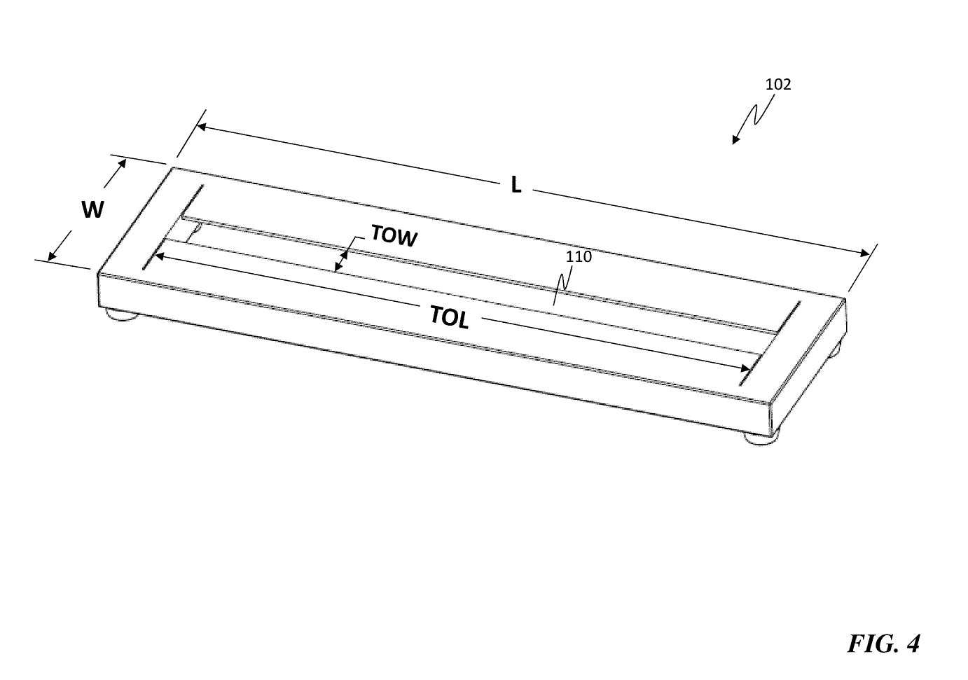

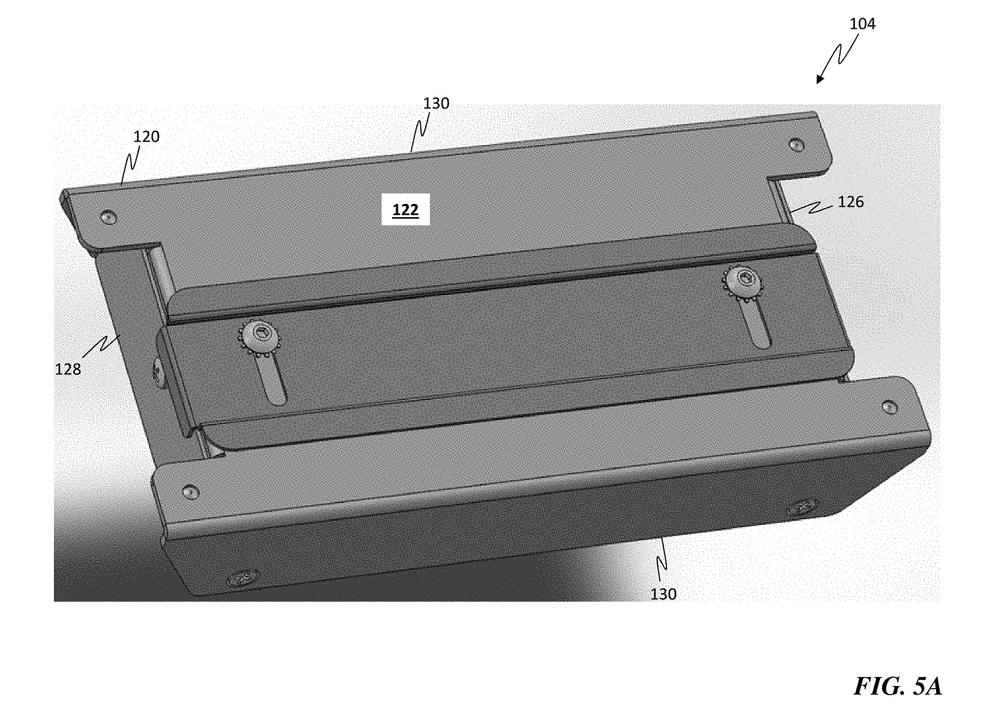

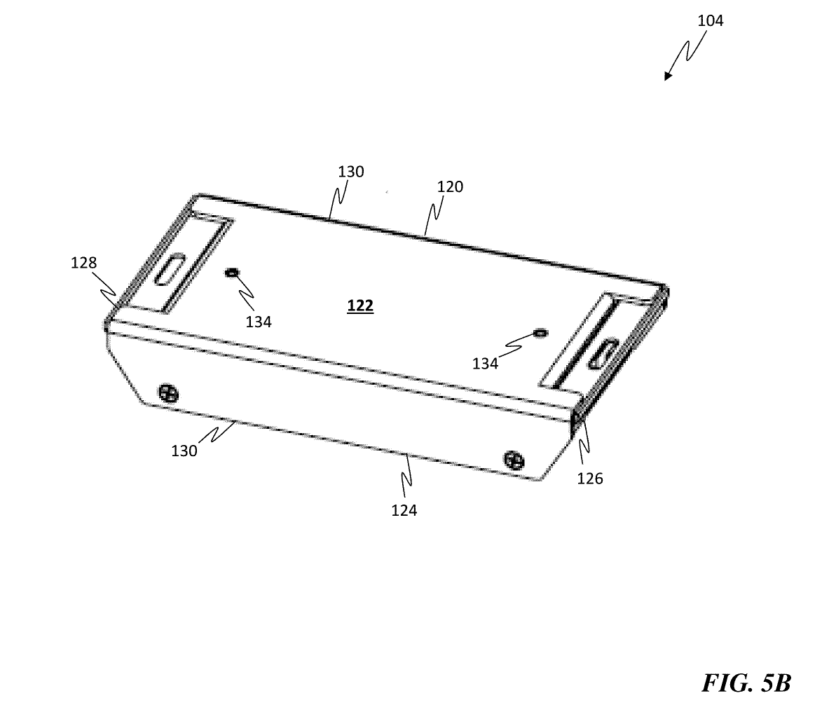

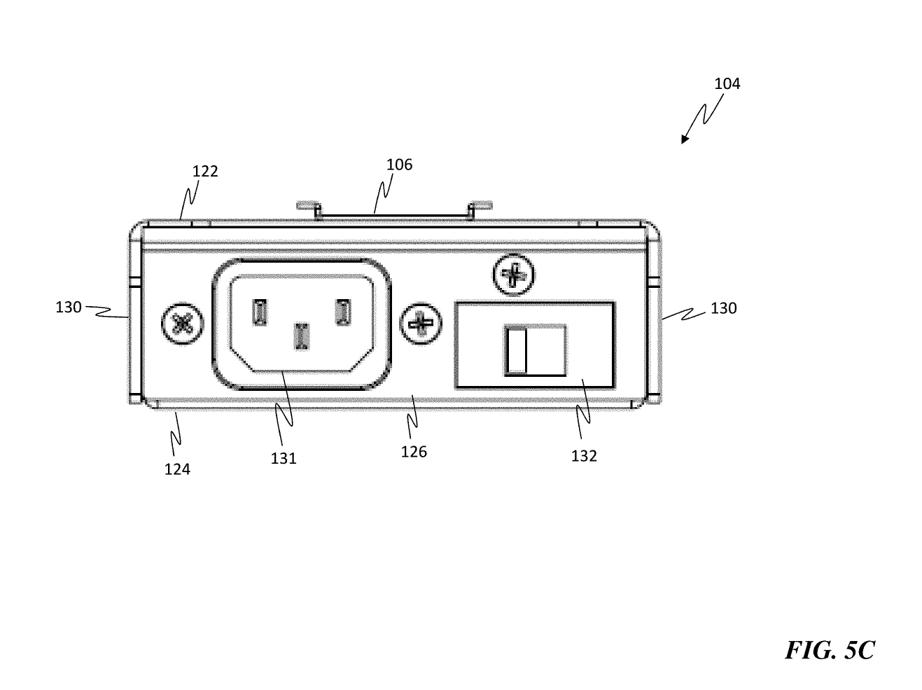

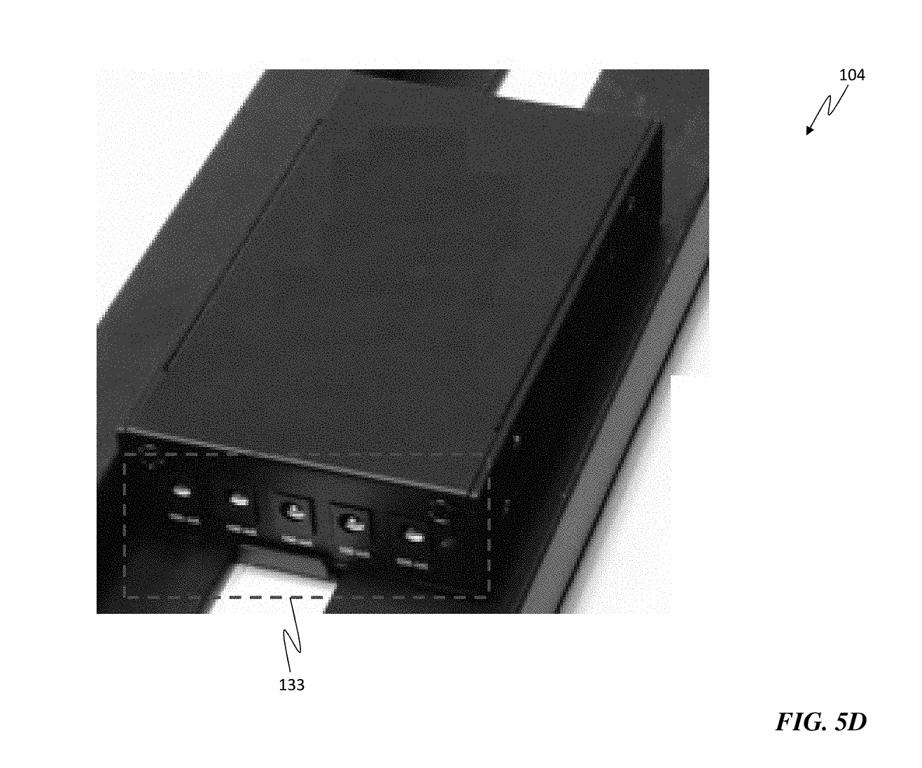

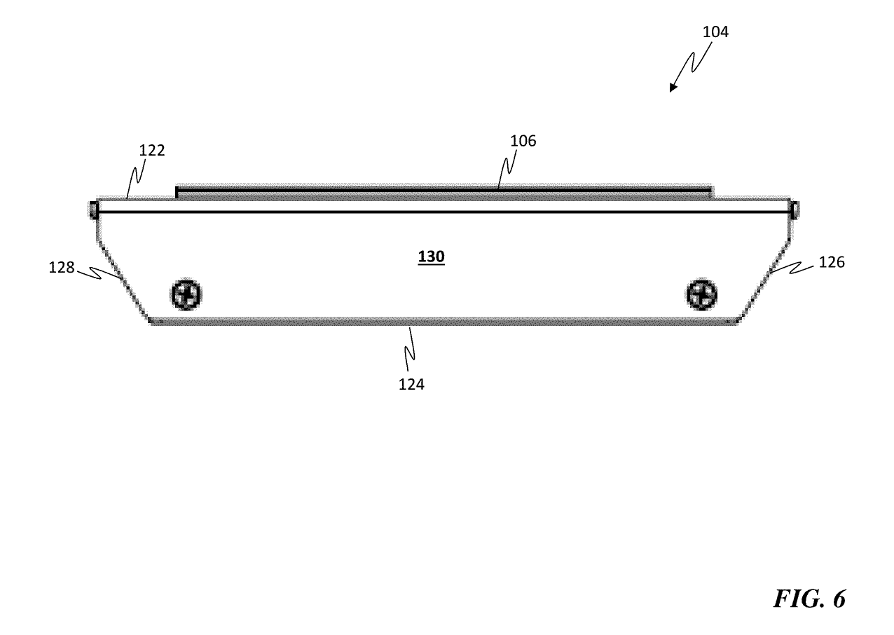

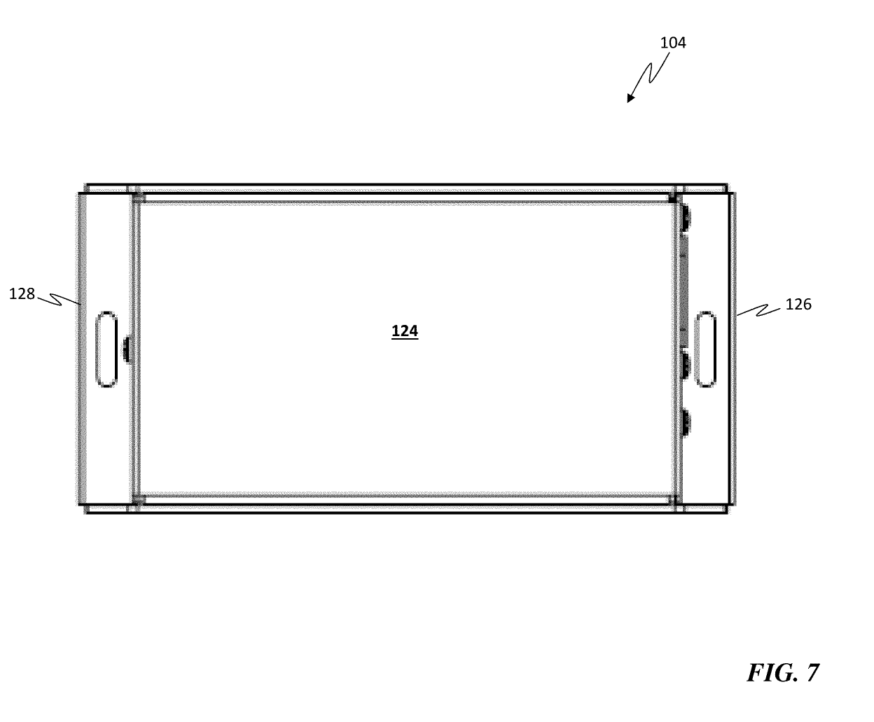

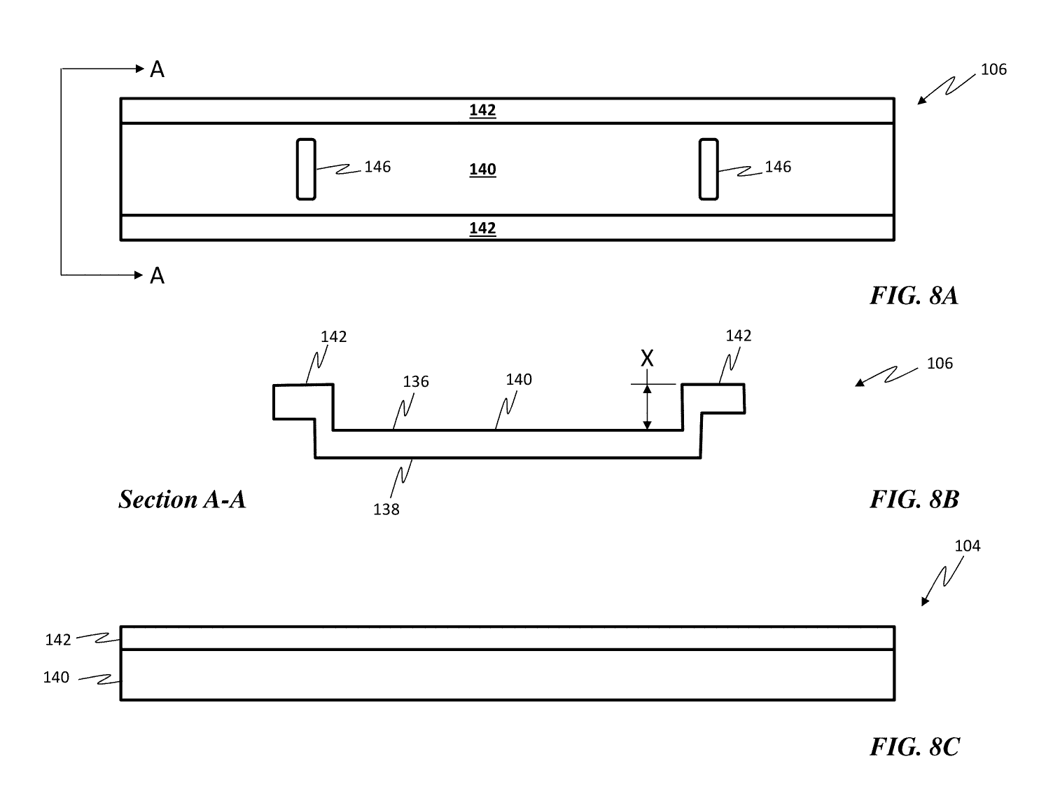

Referring to FIGS. 4-8, one embodiment of the power supply 104 is shown, wherein the power supply 104 includes a supply enclosure 120 having an enclosure top 122, an enclosure bottom 124, an enclosure front 126, an enclosure rear 128 and enclosure sides 130. On one end of the power supply 104, the power supply 104 further includes a power connector 131 and a power switch 132 located on the supply front 124, wherein the power connector 131 and power switch 132 are communicated with power conditioning and power distribution circuitry located within the supply enclosure. On the other end of the power supply 104, the power supply 104 includes one or more power distribution connections 133 which are connected (directly or indirectly) to the power conditioning and power distribution circuitry located within the supply enclosure 120 for distributing power to associated effects pedals. The enclosure top 122 defines one or more threaded enclosure openings 134 which are located to be accessible via the top opening 118 when the power supply 104 is associated with the pedal board 102.

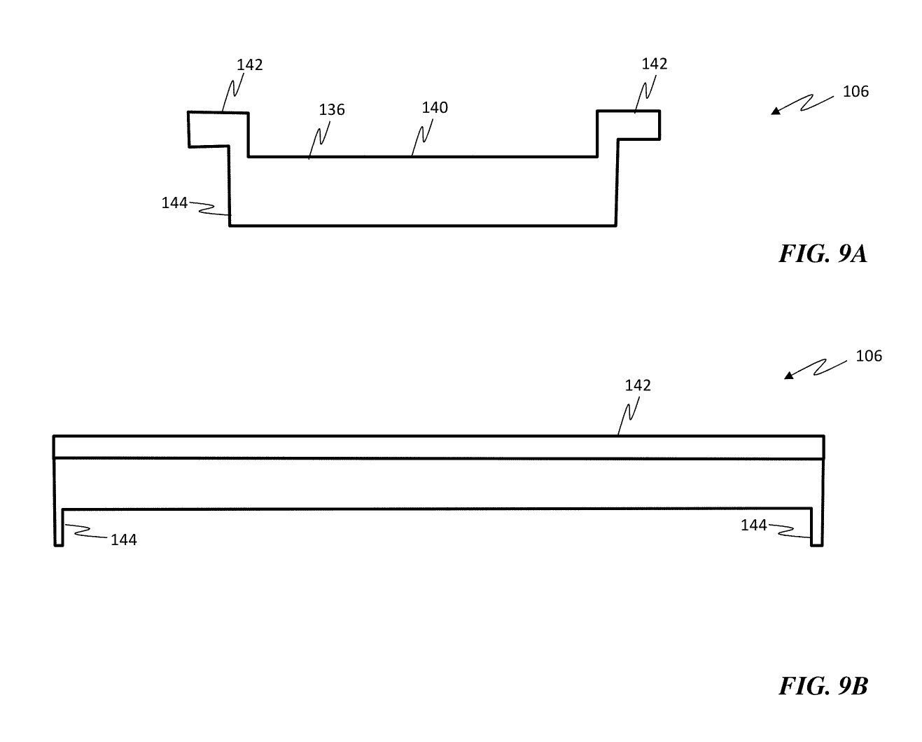

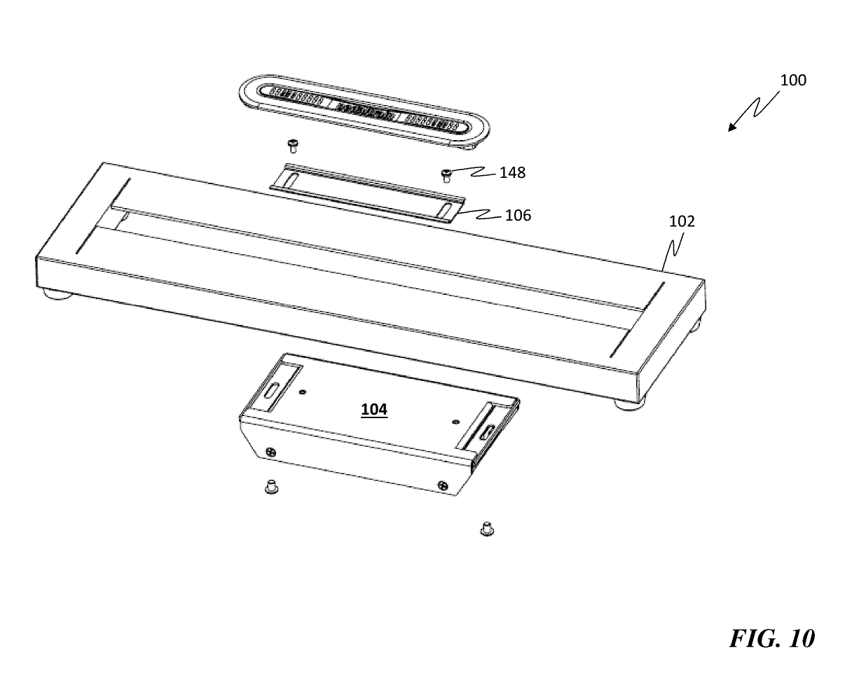

Referring to FIG. 9, the mounting article 106 is substantially rectangular in shape and includes a article top 136, a article bottom 138, a center portion 140, two side portions 142, wherein the two side portions 142 extend upward from the sides of the center portion 140 by approximately X inches. It should be appreciated that in one embodiment, the mounting article includes two end portions 144, wherein the two end portions 144 extend downward from the ends of the center portion 140 by approximately Y inches. The mounting article 106 further defines one or more mounting openings 146 located in the center portion 136 and sized to movably contain a mounting device 148, such as a screw (See FIG. 10). The one or more mounting openings 146 are located such that when the mounting article 106 is associated with the pedal board structure 103 and the power supply 104, the one or more mounting openings 146 are communicated with the one or more threaded enclosure openings 134. It should be appreciated that the center portion 140 includes a center portion width CPW which is approximately equal to the top opening width TOW.

In accordance with one embodiment of the present invention, referring to FIG. 10 the pedal board assembly 100 may be assembled by locating the power supply 104 under the pedal board 102 such that the power supply 104 is located within the board cavity 118, wherein when the power supply is located within the board cavity 118, the one or more threaded enclosure openings 134 are accessible via the top opening 110. The mounting article 106 may then be associated with the pedal board 102 such that the center portion 140 is located within the top opening 118 and such that that one or more mounting openings 146 are aligned with the one or more threaded enclosure openings 134. A screw 148 may then inserted through the one or more mounting openings 146, into one of the one or more threaded enclosure openings 134 and rotated such that the screw 148 threadingly engages the threaded enclosure opening 134 to securely associate the mounting article 106 with the power supply 104. It should be appreciated that in some embodiments, the power supply 104 may be associated with the pedal board 102 such that the power supply 104 is movably (adjustably) associated with the pedal board 102 to allow the power supply 104 to be adjustable as desired. Additionally, it is contemplated that in still yet other embodiments, the power supply 104 may be integrated with the pedal board structure 103. For example, in one embodiment, the power supply 104 may be located within the pedal board structure 103.

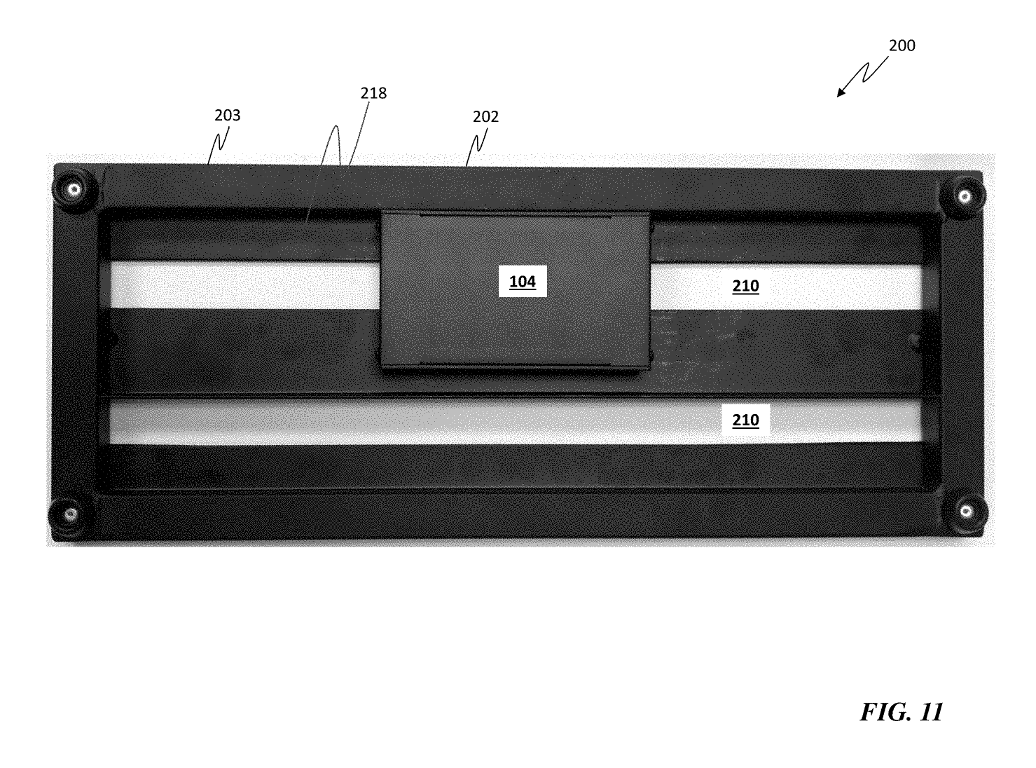

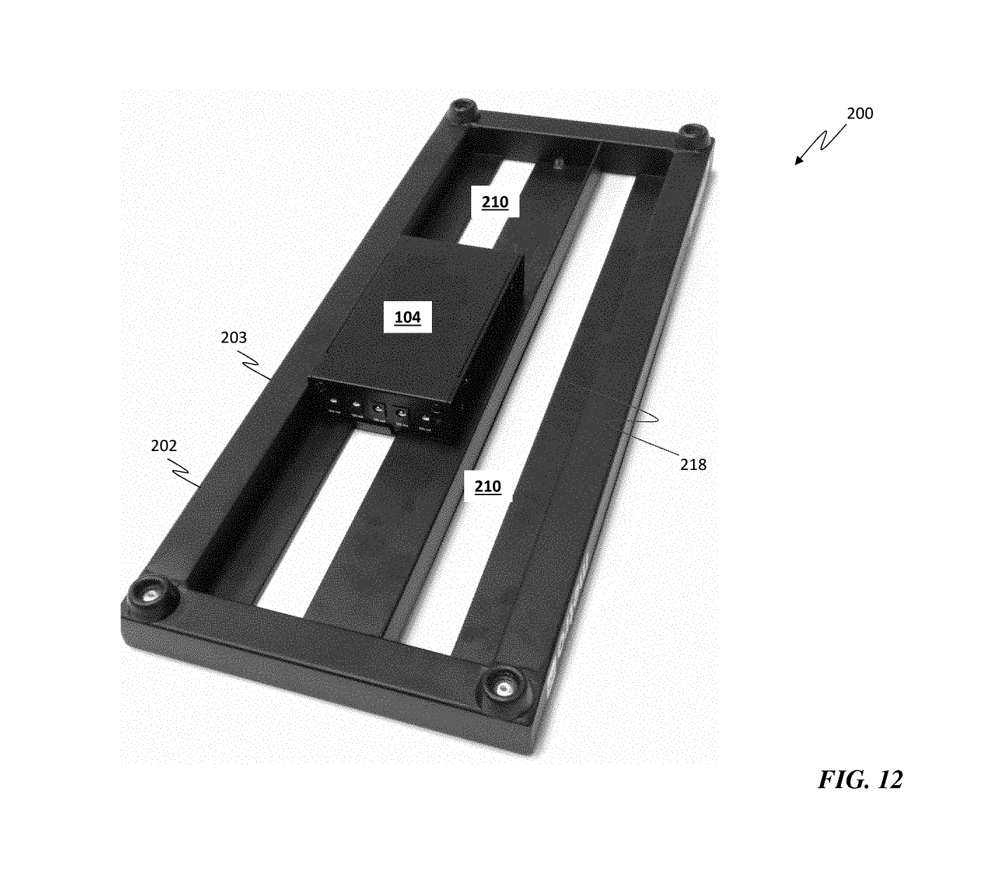

Referring to FIG. 11 and FIG. 12, another embodiment of a pedal board assembly 200 is illustrated, wherein the pedal board assembly 200 includes a pedal board 202 having a pedal board structure 203 which defines multiple top openings 210 (in this case two, but it could be more) communicated with a board cavity 218, wherein the board cavity 218 is configured to contain one or more power supplies 104 which are associated with the pedal board structure 203 using a mounting article 106 as discussed herein above.

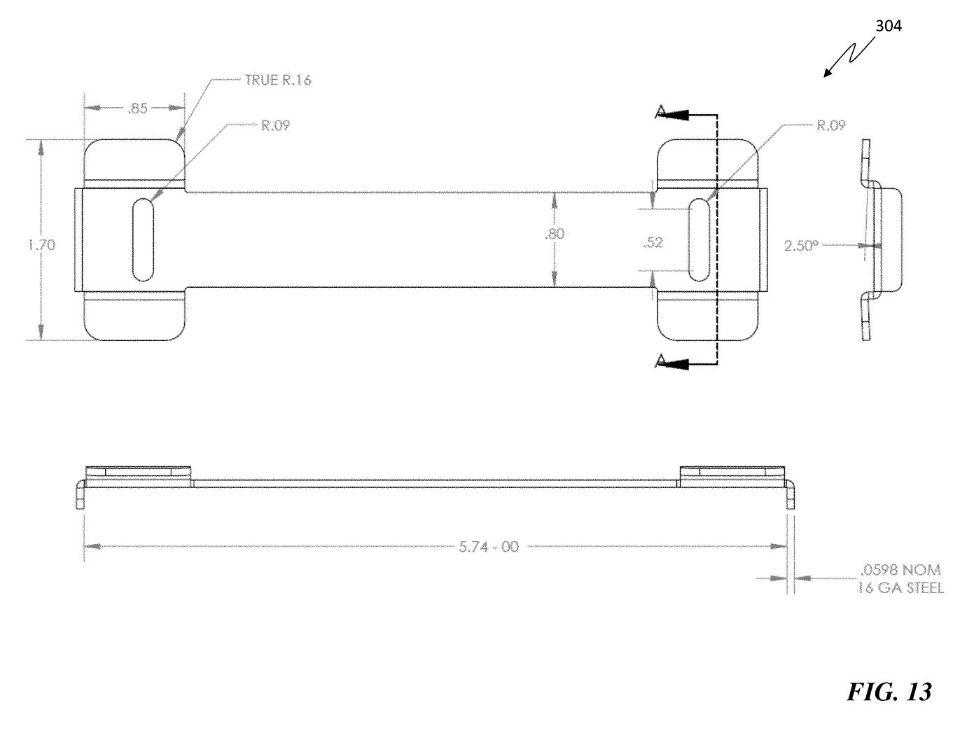

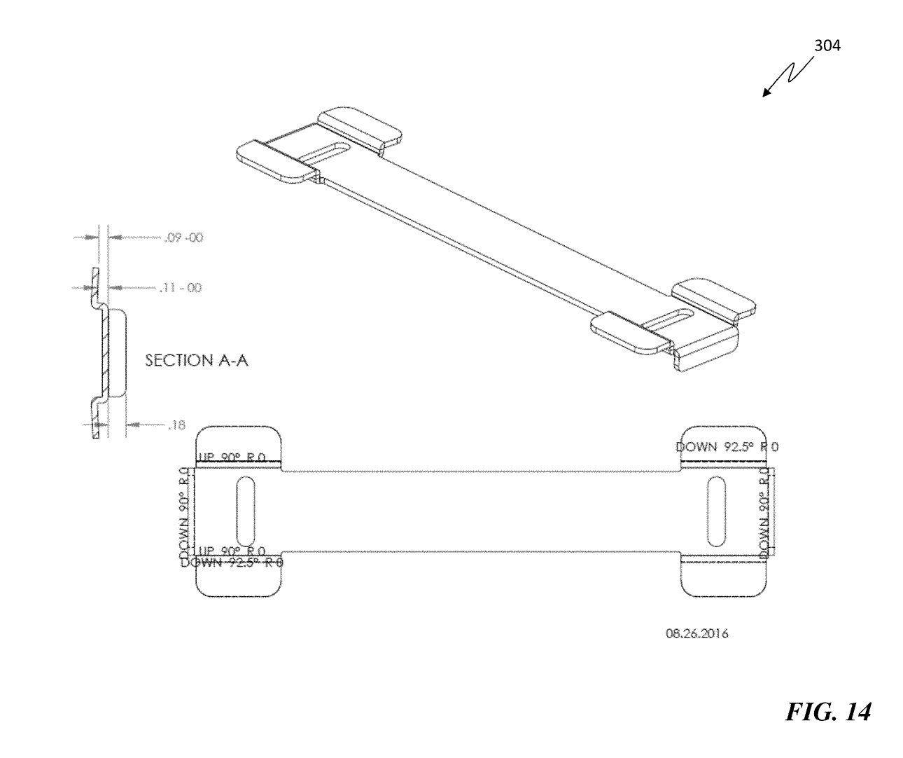

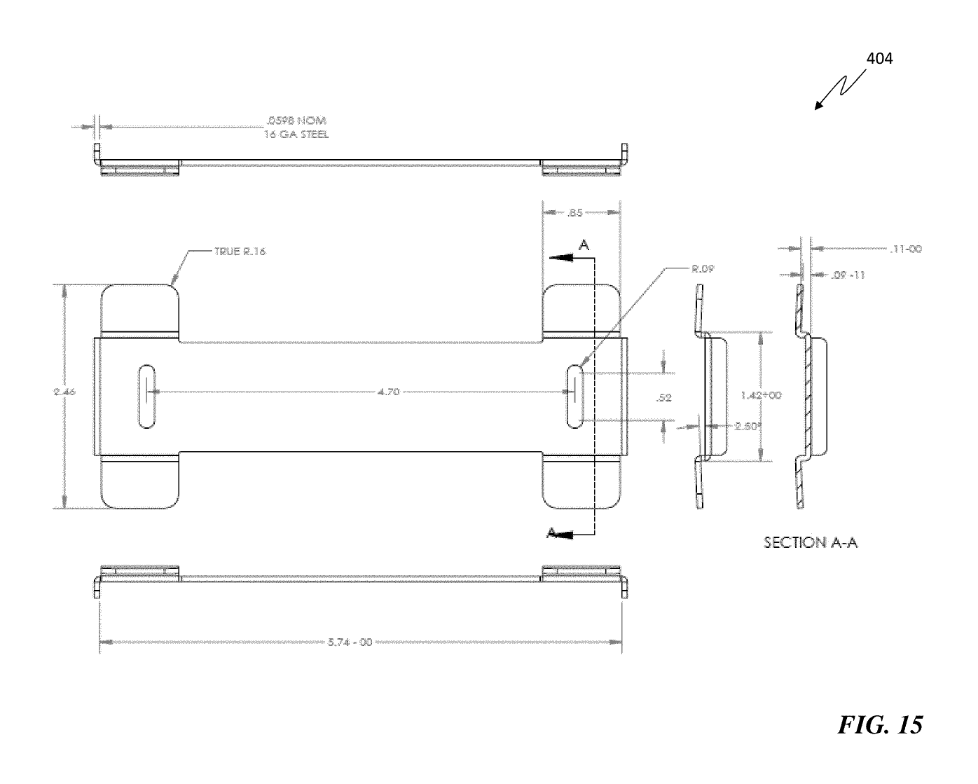

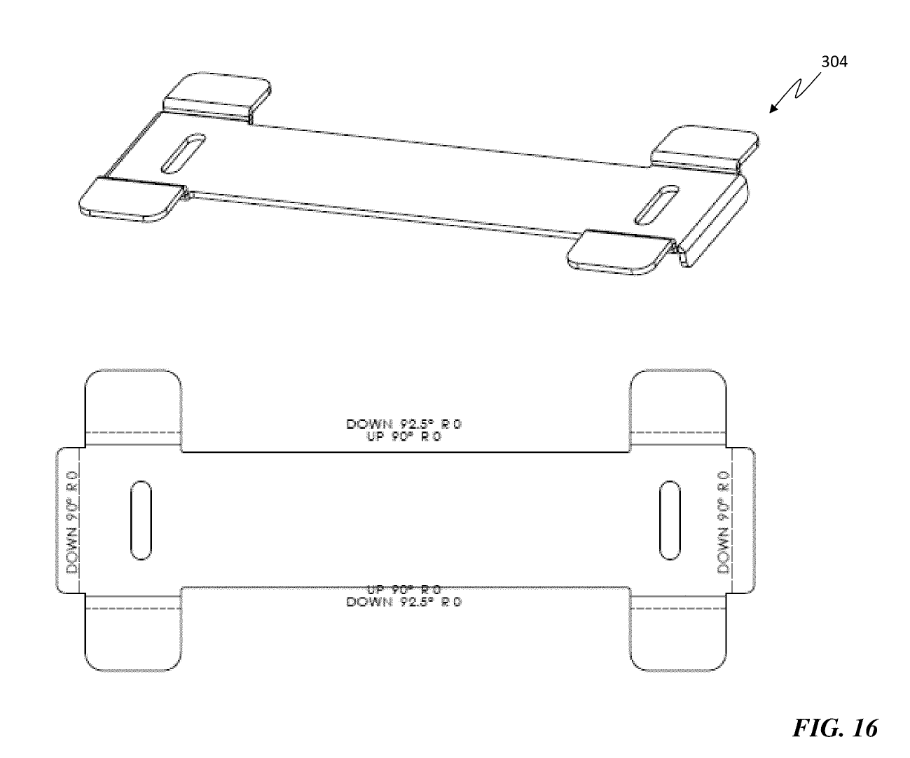

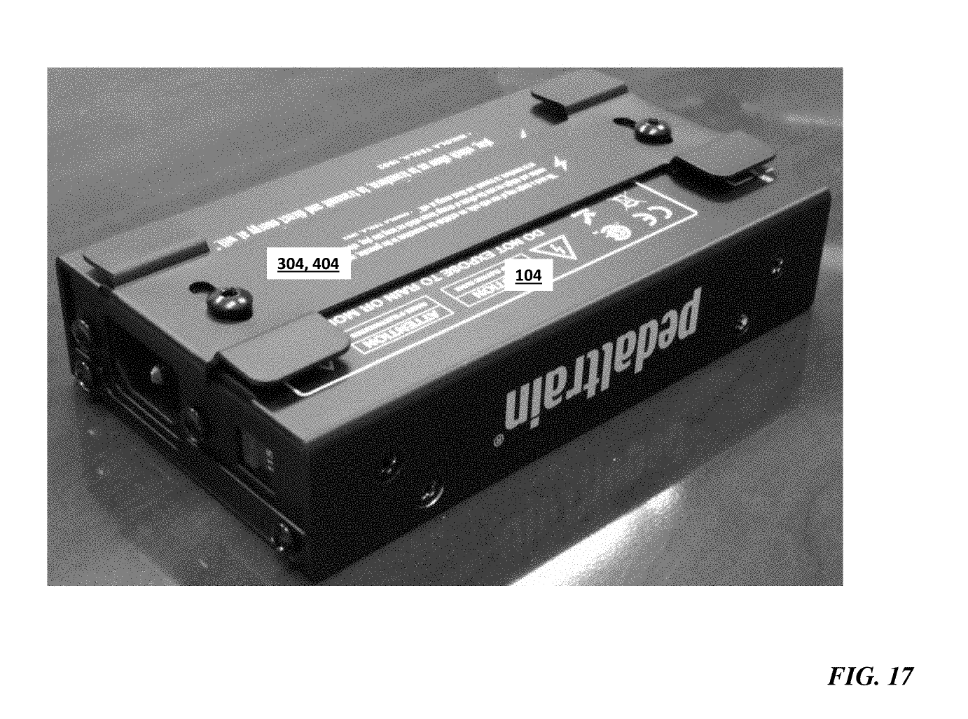

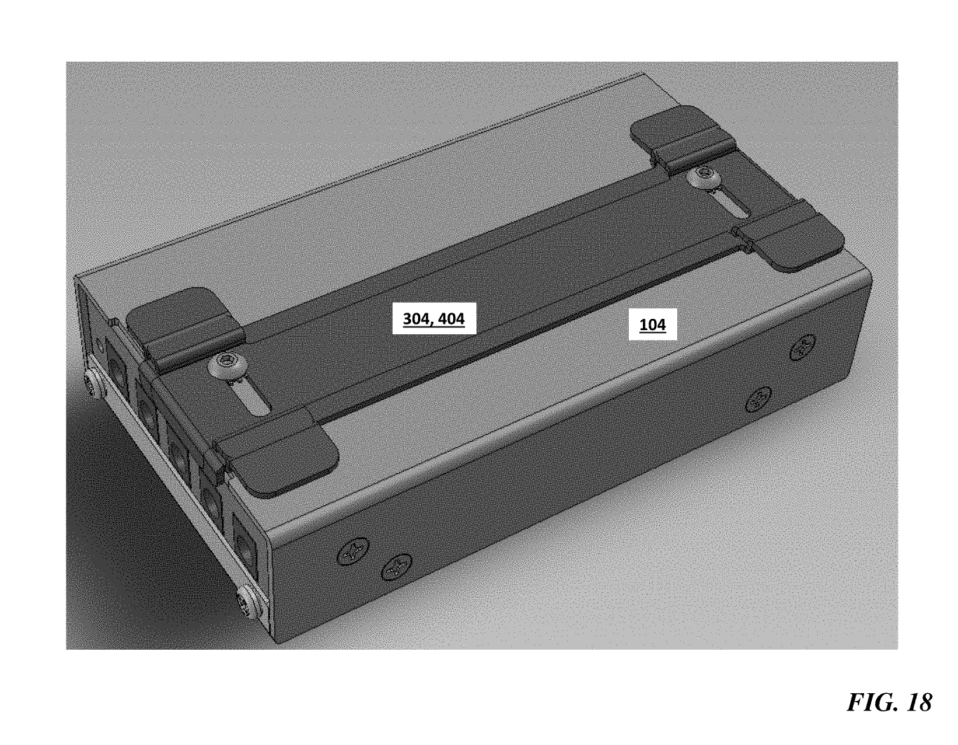

Referring to FIG. 13 and FIG. 14, a mounting article 304 in accordance with another embodiment is illustrated. Referring to FIG. 15 and FIG. 16, a mounting article 404 in accordance with still yet another embodiment is illustrated. Referring to FIG. 17 and FIG. 18, the mounting article 304, 404 is shown associated with the power supply 104, in accordance with one embodiment of the invention.

It should be appreciated that all of the information contained herein may be combined together (individually or wholly) or taken singly to achieve varying embodiments of the invention and to add to the scope of the invention without limiting the invention to a particular embodiment. Moreover, it is contemplated that the component 104 may be any component suitable to the desired end purpose and is not limited to a power supply. Additionally, it is contemplated that the component may be securely connected to the mounting article via any method and/or device suitable to the desired end purpose, such as a clip, a screw, a magnetic device and/or an adhesive. Furthermore, it is contemplated that the pedal board may have more than one opening 110, 210 wherein the opening 110, 210 may extend along any direction (lengthwise, widthwise, etc.). This advantageously allows other components to be mounted to the pedal board and located adjacent the board top 108 and/or the board bottom 112. Thus, in one embodiment, the mounting article 104, 304, 404 may be used to secure the component 104 to the pedal board 102, 202 such that the component is adjacent the board top 108.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. Moreover, embodiments and/or elements of embodiments disclosed herein may be combined as desired. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims and/or information. Moreover, unless specifically stated any use of the terms first, second, etc. do not denote any order or importance, but rather the terms first, second, etc. are used to distinguish one element from another.

We claim:

1. A pedal board assembly, comprising:
a pedal board having a board top, a board bottom and a board length, wherein the pedal board further includes a board opening which communicates the board top with the board bottom and extends at least a portion of the board length;
a component, wherein the component includes a supply enclosure having an enclosure top; and
a mounting article, wherein the mounting article includes an article center portion a first article side portion and a second article side portion, wherein the first article side portion is located on one side of the article center portion and the second article side portion is located on the other side of the article center portion, and
wherein the mounting article is configured to movably associate with the pedal board such that the article center portion is located within the board opening and the first article side portion and the second article side portion are located adjacent the article top, and
wherein when the mounting article is movably associated with the pedal board, the component is securely connected to the article center portion such that the component is located adjacent to the board bottom.

2. The pedal board assembly of claim 1, wherein the article center portion and the component are configured to securely associate each other.

3. The pedal board assembly of claim 1, wherein the article center portion includes a center portion top and a center portion bottom.

4. The pedal board assembly of claim 3, wherein the article center portion includes at least one mount opening which communicates the center portion top with the center portion bottom.

5. The pedal board assembly of claim 1, wherein the component is a power supply having a supply enclosure which includes at least one enclosure mount opening.

6. The pedal board assembly of claim 5, wherein the enclosure mount opening is threaded and is configured to threadingly engage with a mounting screw.

7. The pedal board assembly of claim 1, wherein the pedal board includes at least one pedal board side and at least one pedal board end.

8. The pedal board assembly of claim 7, wherein the at least one pedal board side and at least one pedal board end define a pedal board cavity, wherein the pedal cavity is sized and shaped to movably contain the component.

9. The pedal board assembly of claim 1, wherein the component is securely associated with the mounting article via at least one of a screw, clip, magnet and adhesive.

10. A pedal board assembly, comprising:
a pedal board having a board top, a board bottom and a board length, wherein the pedal board further includes a board opening which communicates the board top with the board bottom and extends at least a portion of the board length; and
a mounting article, wherein the mounting article includes an article center portion a first article side portion and a second article side portion, wherein the first article side portion is located on one side of the article center portion and the second article side portion is located on the other side of the article center portion, and
wherein mounting article is configured to securely associate with a component and movably associate with the pedal board such that the article center portion is located within the board opening and the first article side portion and the second article side portion are located adjacent the article top, and
wherein the mounting article is securely associated with a component, the component is located adjacent to the board bottom.

11. The pedal board assembly of claim 10, wherein the article center portion and the component are configured to securely associate each other.

12. The pedal board assembly of claim 10, wherein the article center portion includes a center portion top and a center portion bottom.

13. The pedal board assembly of claim 12, wherein the article center portion includes at least one mount opening which communicates the center portion top with the center portion bottom.

14. The pedal board assembly of claim 10, wherein the component is a power supply having a supply enclosure which includes at least one enclosure mount opening.

15. The pedal board assembly of claim 14, wherein the enclosure mount opening is threaded and is configured to threadingly engage with a mounting screw.

16. The pedal board assembly of claim 10, wherein the pedal board includes at least one pedal board side and at least one pedal board end, wherein the at least one pedal board side and at least one pedal board end define a pedal board cavity which is sized and shaped to movably contain the component.

17. A pedal board assembly, comprising:
a pedal board having a board top, a board bottom and a board length, wherein the pedal board further includes a board opening which communicates the board top with the board bottom and extends at least a portion of the board length,
wherein the pedal board is configured to movably associate with a mounting article which is configured to move along at least a portion of the board opening.

18. The pedal board assembly of claim 17, further comprising a mounting article,
wherein the mounting article includes an article center portion a first article side portion and a second article side portion, wherein the first article side portion is located on one side of the article center portion and the second article side portion is located on the other side of the article center portion, and
wherein the mounting article is configured to movably associate with the pedal board such that the article center portion is located within the board opening and the first article side portion and the second article side portion are located adjacent the article top, and
wherein when the mounting article is movably associated with the pedal board, a component is securely connected to the article center portion such that the component is located adjacent to the board bottom.

19. The pedal board assembly of claim 17, wherein the pedal board includes at least one pedal board side and at least one pedal board end, wherein the at least one pedal board side and at least one pedal board end define a pedal board cavity which is sized and shaped to movably contain the component.

20. The pedal board assembly of claim 17, wherein the component is a power supply having a supply enclosure which includes at least one enclosure mount opening, wherein the at least one enclosure opening is threaded and is configured to threadingly engage with a mounting screw.
